(19) United States
(12) Patent Application Publication
(10) Pub. No.: US 2015/0169971 A1
(43) Pub. Date: Jun. 18, 2015

(54) CHARACTER RECOGNITION USING SEARCH RESULTS

(71) Applicants: Mark Joseph Cummins, Balmain (AU); Matthew Ryan Casey, San Francisco, CA (US); Alessandro Bissacco, Los Angeles, CA (US)

(72) Inventors: Mark Joseph Cummins, Balmain (AU); Matthew Ryan Casey, San Francisco, CA (US); Alessandro Bissacco, Los Angeles, CA (US)

(21) Appl. No.: 13/606,425

(22) Filed: Sep. 7, 2012

(51) Int. Cl. G06K 9/18; G06F 17/20; G06K 9/72; G06K 9/62

(52) U.S. Cl. CPC G06K 9/18; G06K 9/6201; G06F 17/20; G06K 9/72

(57) ABSTRACT

This disclosure is related to techniques for character recognition. Disclosed techniques include obtaining an electronic image containing depictions of characters, obtaining an initial optical character recognition output for the electronic image, identifying as potentially accurate a set of subsections of the initial optical character recognition output to generate a query, obtaining a search result corresponding to a document and responsive to the query, verifying text in the search result matches the depictions of characters, and outputting computer readable text from the document.

### BACKGROUND

This disclosure relates to techniques for character recognition.

Techniques for optical character recognition (OCR) accept as an input an electronic document containing depictions of characters, and output the characters in computer readable form, e.g., Unicode or ASCII. Such techniques can include staged processing, with stages such as text detection, line detection, character segmentation and character identification. Each stage relies on the information within the document itself, such as optical properties of the depictions of characters.

### SUMMARY

According to various implementations, a computer implemented method is disclosed. The method includes obtaining an electronic image containing depictions of characters, obtaining an initial optical character recognition output for the electronic image, identifying as potentially accurate a set of subsections of the initial optical character recognition output to generate a query, and obtaining a search result corresponding to a document and responsive to the query. The method also includes verifying text in the search result matches the depictions of characters, and outputting computer readable text from the document.

The above implementations can optionally include one or more of the following. The method can include obtaining at least one search result for multiple sets of the subsections. The method can include attributing a rating to each of a plurality of search results, where a rating for the search result corresponding to the document is an extremum among ratings for others of the plurality of search results. The rating for the search result corresponding to the document can include a sum of a plurality of ratings for the search result corresponding to the document, each of the plurality of ratings corresponding to a different one of multiple pluralities of the subsections. The obtaining at least one search result can include: matching the query to a plurality of search results using an index to resources on a network, and selecting the search result corresponding to the document. The identifying can include matching portions of the initial optical character recognition output to a set of known words. The verifying can include determining that the plurality of subsections appear in the same order in the document as they do in the electronic image. The obtaining at least one search result can indicate that a first resource on a network and a second resource on a network both contain a copy of the document, and the method can further include selecting from among the first resource and the second resource based on at least a number of links to the first resource and a number of links to the second resource. The method can also include calculating a distinctiveness score for each of the plurality of the subsections.

According to various implementations, a system is disclosed. The system includes one or more computers configured to perform operations including: obtaining an electronic image containing depictions of characters, obtaining an initial optical character recognition output for the electronic image, identifying as potentially accurate a set of subsections of the initial optical character recognition output to generate a query, obtaining a search result corresponding to a document and responsive to the query, verifying text in the search result matches the depictions of characters, and outputting computer readable text from the document.

The above implementations can optionally include one or more of the following. The one or more computers can be configured to obtain at least one search result for multiple sets of the subsections. The one or more computers can be configured to attribute a rating to each of a plurality of search results, where a rating for the search result corresponding to the document is an extremum among ratings for others of the plurality of search results. The rating for the search result corresponding to the document can include a sum of a plurality of ratings for the search result corresponding to the document, each of the plurality of ratings corresponding to a different one of multiple pluralities of the subsections. The one or more computers configured to obtain at least one search result can be further configured to: match the query to a plurality of search results using an index to resources on a network, obtain a plurality of search results using the index, and select the search result corresponding to the document. The one or more computers configured to identify can be configured to match portions of the initial optical character recognition output to a stored set of known words. The one or more computers configured to verify can be further configured to determine that the plurality of subsections appear in the same order in the document as they do in the electronic image. The one or more computers can be further configured to select from among the a first resource containing a copy of the document and a second resource containing a copy of the document based on at least a number of links to the first resource and a number of links to the second resource. The system can further include one or more computers configured to calculate a distinctiveness score for each of the plurality of the subsections.

According to various implementations, computer readable media are disclosed. The computer readable media contain instructions which, when executed by one or more processors, cause the one or more processors to: obtain an electronic image containing depictions of characters, obtain an initial optical character recognition output for the electronic image, identify as potentially accurate a set of subsections of the initial optical character recognition output to generate a query, obtain a search result corresponding to a document and responsive to the query, verify text in the at least one search result matches the depictions of characters, and output computer readable text from the document.

The above implementations can optionally include one or more of the following. The computer readable media can contain further instructions, which, when executed by the one or more processors, cause the one or more processors to obtain at least one search result for multiple sets of the subsections. The computer readable media can include further instructions, which, when executed by the one or more processors, cause the one or more processors to attribute a rating to each of a plurality of search results, where a rating for the search result corresponding to the document is an extremum among ratings for others of the plurality of search results.

Disclosed techniques provide certain technical advantages. Some implementations provide accurate character recognition when optical character recognition is incapable of producing accurate results. Such implementations provide more thorough and accurate character recognition, thus achieving a technical advantage.

### DESCRIPTION OF DRAWINGS

The accompanying drawings, which are incorporated in and constitute a part of this specification, illustrate implementations of the disclosed technology and together with the description, serve to explain the principles of the disclosed technology. In the figures:

FIG. 1 is a schematic diagram of an example implementation;

FIG. 2 is a schematic diagram of an example system according to some implementations; and

FIG. 3 is a flowchart of a method according to some implementations.

### DETAILED DESCRIPTION

Optical character recognition techniques sometimes produce highly inaccurate outputs when the input images are unclear. Relying solely on the input image itself for character recognition can sometimes be insufficient for producing a complete and accurate set of computer readable characters. Disclosed techniques apply an OCR technique to an input image, identify portions of the OCR output that are potentially accurate, and then search an index for a matching search result document that includes such portions. Once the techniques identify the matching document and verify that it corresponds to the input image, the techniques output computer readable text from the matching document that corresponds to the depictions of text in the input image.

Reference will now be made in detail to example implementations of the present teachings, which are illustrated in the accompanying drawings. Where possible the same reference numbers will be used throughout the drawings to refer to the same or like parts.

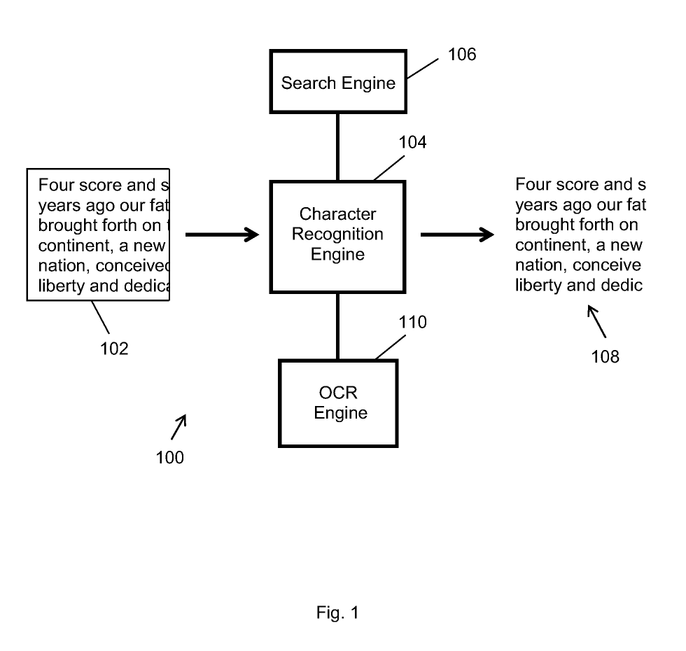

FIG. 1 is a schematic diagram of an example implementation. In particular, FIG. 1 depicts character recognition engine 104 operably coupled to search engine 106. Character recognition engine 104 can include or be part of a general purpose computer. Character recognition engine 104 includes or is communicatively coupled to OCR engine 110.

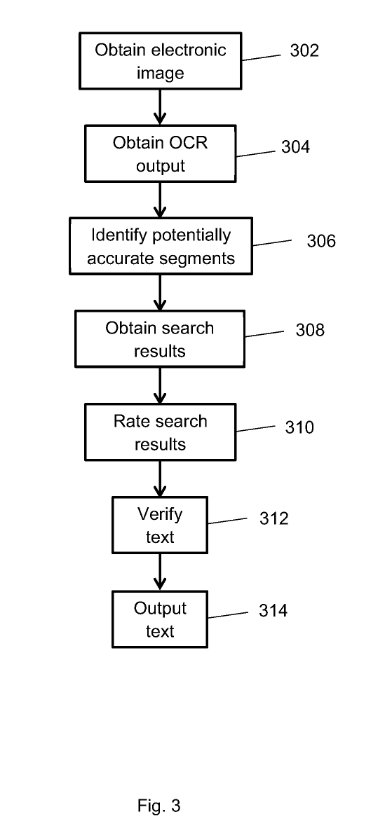

The system depicted schematically in FIG. 1 can operate as follows. A user provides input image 102 containing depictions of characters to character recognition engine 104. Character recognition engine 104 supplies input image 102 to OCR engine 110, which provides an initial output of computer readable characters. Character recognition engine 104 analyzes the initial output to identify output portions that are potentially accurate. Character recognition engine 104 conveys various combinations of such potentially accurate output portions to search engine 106 as queries. Search engine 106 provides search results in response to each such query to character recognition engine 104. Each search result includes an excerpt of the corresponding document as well as a uniform resource locator for the resource, e.g., web page, from which the document was obtained. Character recognition engine 104 rates the search results as part of the process for identifying a document indexed by search engine 106 that matches document 102. The rating process is described in detail below in reference to block 310 of FIG. 3. Once identified, character recognition engine 104 verifies the matching document corresponds to the input image 102 by, for example, confirming that the potentially accurate portions appear in the same order in both documents. Character recognition engine 104 then outputs computer readable characters 108 from the matching document that corresponds to input image 102.

Note that in some implementations, character recognition engine 104 restricts the output computer readable characters 108 to the portions of the matching document that correspond to the visible portions of input image 102. In such implementations, character recognition engine 104 may output word fragments if only portions of such words are visible in input image 102.

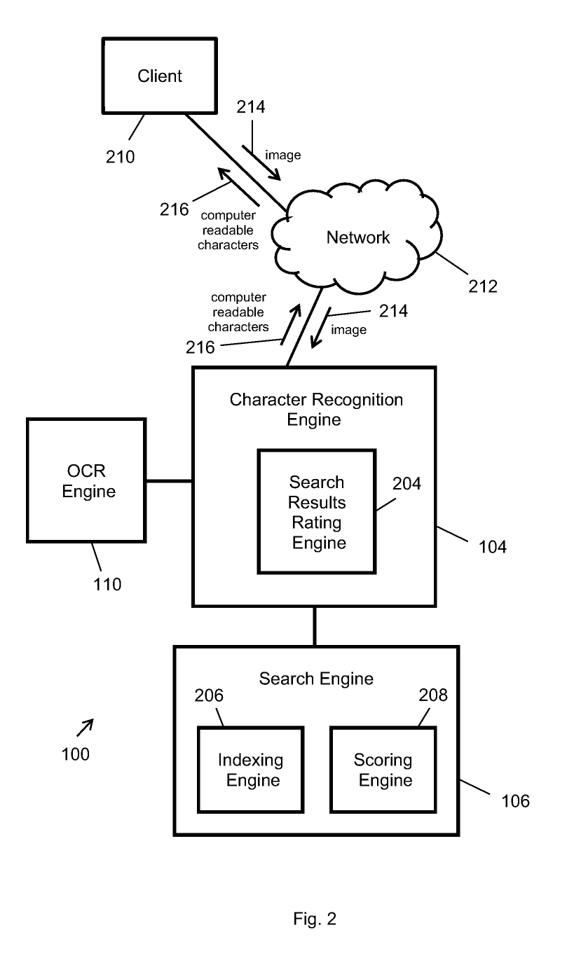

FIG. 2 is a schematic diagram of an example system 100 according to some implementations. System 100 includes character recognition engine 104. Character recognition engine 104 includes, or is communicatively coupled to, OCR engine 110. Character recognition engine 104 is also coupled to network 212, for example, the internet. Client 210 is also coupled to network 212 such that character recognition engine 104 and client 210 are communicatively coupled. Client 210 can be a personal computer, tablet computer, desktop computer, or any other computing device.

OCR engine 110 is capable of accepting an input image containing depictions of characters and outputting computer readable characters based on visual properties of the input image. OCR engine 110 can process input images based on staged processing, where such stages can include text detection, line detection, character segmentation and character identification. OCR engine 110 uses information in the input image to produce computer readable characters.

Character recognition engine 104 further includes search results scoring engine 204. Search results scoring engine 204 ranks search results identified by search engine 106 in order to identify a matching document corresponding with the input image. Details of how search results scoring engine 204 can perform such a ranking appear below in reference to block 310 of FIG. 3.

Character recognition engine 104 is also communicatively coupled to search engine 106. Search engine 106 can include a web-based search engine, a proprietary search engine, a document lookup engine, or a different search engine. Search engine 106 includes indexing engine 206, which includes an index of a large portion of the internet or other network such as a local area network (LAN) or wide area network (WAN). When search engine 106 receives a search query, it matches it to the index using indexing engine 206 in order to retrieve search results. More particularly, using known techniques, search engine 106 identifies search results that are responsive to the search query based on matching keywords in the index to the query. (Although keyword matching is described here as an example, implementations can use other techniques for identifying search results responsive to a query instead of, or in the alternative.)

Search engine 106 further includes scoring engine 208. Scoring engine 208 attributes a score to each such search result, and search engine 106 orders the search results based on the scores. Each score can be based upon, for example, an accuracy of matching between, on the one hand, the search query and, on the other hand, keywords present in the index. The ranking can alternately, or additionally, be based on a search results quality score that accounts for, e.g., a number of incoming links to the resources corresponding to the search results. Search engine 106 is thus capable of returning ordered search results in response to a search query.

In operation, a user of client 210 sends image 214 to character recognition engine 104 through network 212. Character recognition engine 104 processes image 214 as described herein to obtain corresponding computer readable characters 216. Character recognition engine 104 then conveys computer readable characters 216 back to client 210 through network 212.

FIG. 3 is a flowchart of a method according to some implementations. At block 302, OCR engine 104 receives an electronic image containing depictions of text. OCR engine 104 can receive the document over a network such as the internet, for example. The document can be the result of an electronic scan of a physical document, can be a photograph of a scene containing characters, can be partially or wholly computer generated, or can originate in a different manner.

At block 304, character recognition engine 104 obtains the output of an OCR process performed on the document by OCR engine 110. The output can be to a file or memory location containing data representing Unicode or ASCII text, for example. The output can contain both erroneous and accurate segments of text.

At block 306, character recognition engine 104 identifies potentially accurate segments of text in the output. Implementations can use several techniques, alone or in combination, for doing so.

Character recognition engine 104 can identify potentially accurate segments of text by matching individual terms from the output to the contents of an electronic dictionary and set of proper nouns. Segments of text that include only matched terms can be considered potentially accurate according to this technique.

Some implementations utilize scores provided by OCR engine 110 to judge the potential accuracy of terms appearing in the output. In general, OCR engine 110 may associate a score, e.g., a probability, to each term in its output. Each score indicates a confidence level that the associated term has been correctly recognized. In some implementations, a segment of the output is considered potentially accurate if each term within it has an OCR engine confidence score that exceeds a threshold value.

Character recognition engine 104 can identify potentially accurate segments of text by using a language model. A language model can, for example, assign probabilities to sequences of terms. The probabilities can reflect the likelihood of the sequences appearing in a given language, e.g., English. Thus, a language model can analyze segments of the output, and segments whose assigned probability exceeds a threshold value can be considered potentially accurate.

Character recognition engine 104 can identify potentially accurate segments of text by using a model of geometric information about words. Such a model can assign a probability to sequences of terms. The probabilities can reflect the likelihood of the sequences of terms having particular geometric properties such as size and position. This, a model of geometric information about words can analyze segments of the output, and segments whose assigned probability exceeds a threshold value can be considered potentially accurate.

Terms in a particular segment of text that is judged as potentially accurate by any, or a combination, of the aforementioned techniques can be excluded if they appear next to terms that are not identified as potentially accurate. To illustrate this process, an example output from a OCR engine is provided below in Table 1.

TABLE 1
Example OCR Output

psvrls IVoiu n strict, roc'cl-forwnrcl plpoliiio unci rc'iilnroH il,
by vorilicnliou IVaiiu'worlt HiinullimooiiKly proccsHiiig lt iiiff polhosivs,
(ii) uses syiit.hotic lbtils to triiiii tlio mi cl ucod for timo-cousiiining
nccinisitioti and laljolinK of II V dnla and (iii) exploits Maximally Stablo
Extremal Hotfc whidi provides robustness to geometric and illuiniiialion ci
The porlbrmanco of the method is evaluated on two standi On the
ChnrT'lk datnsot, a recognition rate of 72% is ac llichcr ilin
Kl.nlr-.nr-l.lio-ni-l.. Tlif> nntmr is I, to won

Character recognition engine 104 can provide an initial identification of segments of the output that are potentially accurate by any of the aforementioned techniques, alone or in combination. Although Table 1 includes the segment “provides robustness to geometric and”, implementations can exclude the terminal term “and” because it abuts the inaccurate term “illuiniiialion”. As another example, although Table 1 includes the segment “is evaluated on two”, implementations can exclude the initial term “is” because it abuts the inaccurate term “metliod”. Implementations can use any of the techniques described above, alone or in combination, to provide initial identification of segments of the output that are potentially accurate, and to provide identifications of terms that are inaccurate for exclusion purposes. Relative to Table 1, an example of excluding terms from segments of text because they appear next to terms judged to be inaccurate appears below in Table 2.

TABLE 2
Segments Identified As Potentially Accurate

| | |
|---|---|
| Segment 0 | provides robustness to geometric |
| Segment 1 | exploits maximally |
| Segment 2 | evaluated on two |
| Segment 3 | recognition rate |
| Segment 4 | strict |
| Segment 5 | uses |

Any of the aforementioned techniques for identifying potentially accurate segments of text can be used alone, or in combination. For combinations of techniques, such techniques can be used sequentially. For example, a first technique can identify potentially accurate segments of text, then a second technique can exclude all or part of such segments that the second technique does not identify as potentially accurate. Such sequential combinations can be extended to include multiple techniques. Alternately, or in addition, multiple techniques can be used in a collaborative manner. For example, multiple techniques can be used to each separately identify segments of potentially accurate text. Each technique can associate a score to particular segments. Such scores can be binary, e.g., 0 or 1, or take on additional values, e.g., any value between 0 and 1. Segments for which the associated score exceeds a threshold can be considered potentially accurate and passed to the next step. The example ways to combine techniques described above are not limiting; other combinations can be used to identify potentially accurate segments of text.

At block 308, character recognition engine 104 obtains search results for various combinations of the potentially accurate segments using search engine 106. Before doing so, character recognition engine 104 selects the combinations of segments to be used as search queries as follows.

To select potentially accurate segments to use as search queries, first, character recognition engine 104 associates a distinctiveness score to each potentially accurate segment. The distinctiveness score can be computed as follows. For each term in a particular segment, character recognition engine 110 counts, from among a corpus of documents, a number of documents in which the term appears. Character recognition engine then divides the number of documents in which the term appears by the total number of documents in the corpus, thus obtaining a document frequency proportion for each term in the potentially accurate segment. The corpus of documents can be, for example, the documents indexed by search engine 106; in such implementations, the total number of document is the total number of documents indexed by indexing engine 206. For purposes of calculating distinctiveness scores, terms can be combined if such combination is customary and reflected in the dictionary and list of proper nouns, e.g., the two terms “white” and “house” can be treated as the single term “white house” if they appear together. Once each term in a potentially accurate segment has an associated document frequency proportion, character recognition engine 104 determines a distinctiveness score for the entire potentially accurate segment by calculating a product of the document frequency proportions for each term in the segment, then taking the reciprocal of the product. This reciprocal reflects a distinctiveness of the segment, with larger values reflecting higher levels of distinctiveness.

Second, character recognition engine 110 orders the potentially accurate segments according to distinctiveness scores, from lowest to highest. Thus, the top segments in the ordered list of segments are more distinct than later segments in the list.

Third, character recognition engine 104 selects the top few segments from the ordered list of segments. In some implementations, character recognition engine 104 searches the top few potentially accurate segments in combination. Such implementations thus search, e.g., the first segment, the first segment in combination with the second segment, the first segment in combination with the second and third segments, and so on. In some implementations, character recognition engine also searches the top few segments in combination, while excluding one of the top segments. Such implementations thus search, e.g., the first segment, the first segment in combination with the second segment, the second segment, the first segment in combination with the second and third segments, the first and third segments, the second and third segments, and so on. Implementations that exclude one segment from the top few segments address the cases where one or more of the top few segments is in fact inaccurate despite being identified as potentially accurate. Implementations can search any number of potentially accurate segment combinations, e.g., any number from 1 to 31.

To conclude block 308, character recognition engine 104 conveys the segment combinations to search engine 106 to be used as search queries. Search engine 106 receives the queries and obtains search results in a known manner, e.g., by matching the queries to indexed document portions using indexing engine 208. Once matched by indexing engine 206, scoring engine 208 attributes a score to each search result based on, e.g., one or both of matching accuracy and search result quality, and search engine 106 orders the search results based on the scores. Search engine 106 provides the search results to character recognition engine 104.

At block 310, search results rating engine 204 rates the search results received from search engine 106 for the purpose of identifying a document matching the input image received at block 302. An example rating scheme is described presently. First, search results rating engine 204 identifies duplicative search results across all queries. Search results rating engine 204 can achieve this by applying a similarity metric to pairs of search results, and identifying as near-identical search results whose similarity metric value exceeds some preset threshold. Second, search results rating engine 204 attributes a rating to each set of identical, or near-identical as determined by the similarity metric, search results. For each such set of identical or near-identical search results, search results rating engine 204 computes a weighted sum of the distinctiveness scores of the underlying potentially accurate segments used as search queries to obtain the search results. The weights in the weighted sum can be by, for example, reciprocals of the search results' order according to scoring engine 208 of search engine 106 and/or reciprocals of the search results' scores according to scoring engine 208 of search engine 106. Once search results rating engine 204 attributes a rating to each set of identical or near-identical search results, character recognition engine 104 identifies the top-rated search result. In some implementations, if the rating of the top-rated search result fails to exceed a threshold confidence level, the process terminates.

In situations where the top rated search result is among multiple search results that are identical or near-identical, character recognition engine 104 can select the search result and associated document as follows. In some implementations, the highest individually rated search result is used. In some implementations, the search result with the highest quality score is used, e.g., the search result from the resource with the most incoming links.

In the above scheme by which search results rating engine 204 attributes a rating to each set of identical or near-identical search results, a higher rating indicates a closer match. However, other rating schemes may be used in which a lower rating indicates a better match. In either scheme, however, an extremum, e.g., maximum or minimum, indicates a candidate for a best match.

At block 312, character recognition engine 104 verifies the correctness of the top-rated search result. Character recognition engine 104 can accomplish this by, for example, verifying that the potentially accurate segments present in the top-rated search result appear in the same order as they do in the input image. If so, the process proceeds to block 314. If not, the process verifies the next highest rated search results, e.g., the top ten highest rated search results, in the same manner, terminating if no search results are verified as correct.

At block 314, the process outputs text from the verified search result document. The process can obtain the text from a copy of the document archived by search engine 106, or from the original document on the network resource indexed by indexing engine 206.

In some implementations, the output text corresponds to the text visible in the input document received at block 302. In such implementations, text not visible in the input document is excluded from the output. Other implementations include additional text, e.g., to complete partial words. Yet other implementations output the entire text of the document verified at block 312.

The text output at block 314 can be output in various ways. Some implementations output the text by conveying it to a user or computing resource on a network. Other implementations output the text into a file corresponding to the input image as if it were OCR data. Yet other implementations output the text by displaying it on a computer display.

In general, systems capable of performing the disclosed techniques can take many different forms. Further, the functionality of one portion of the system can be substituted into another portion of the system. Each hardware component can include one or more processors coupled to random access memory operating under control of, or in conjunction with, an operating system. Search engine 106 and character recognition engine 104 can include network interfaces to connect with each-other and with clients via a network. Such interfaces can include one or more servers. Further, each hardware component can include persistent storage, such as a hard drive or drive array, which can store program instructions to perform the techniques disclosed herein. That is, such program instructions can serve to perform techniques as disclosed. Other configurations of search engine 106, character recognition engine 104, associated network connections, and other hardware, software, and service resources are possible.

The foregoing description is illustrative, and variations in configuration and implementation may occur. Other resources described as singular or integrated can in implementations be plural or distributed, and resources described as multiple or distributed can in implementations be combined. The scope of the present teachings is accordingly intended to be limited only by the following claims.

1. A computer implemented method, the method comprising:
obtaining an electronic image containing depictions of characters;
obtaining an initial optical character recognition output for the electronic image, wherein the initial optical character recognition output comprises one or more segments of one or more terms;
identifying as potentially accurate one or more of the segments of the initial optical character recognition output;
generating a query that comprises terms from one or more of the potentially accurate segments of the initial optical character recognition output;
obtaining, responsive to the query, a search result that corresponds to a document;
verifying that text in the search result matches the depictions of characters; and
outputting computer readable text from the document that corresponds to the search result as at least a portion of a final optical character recognition output for the electronic image.

2. The method of claim 1, further comprising:
generating multiple queries, wherein each query comprises terms from one or more of the potentially accurate segments of the initial optical character recognition output; and
obtaining at least one search result for each of the multiple queries.

3. The method of claim 2, further comprising attributing a rating to each of a plurality of search results, wherein a rating for the search result corresponding to the document is an extremum among ratings for others of the plurality of search results.

4. The method of claim 3, wherein the rating for the search result corresponding to the document comprises a sum of a plurality of ratings for the search result corresponding to the document, each of the plurality of ratings corresponding to a different one of the multiple queries.

5. The method of claim 1, wherein the obtaining the search result that corresponds to the document comprises:
providing the query to a search engine;
obtaining a plurality of search results for the query from the search engine; and
selecting the search result corresponding to the document from the plurality of search results.

6. The method of claim 1, wherein the identifying comprises matching portions of the initial optical character recognition output to a set of known words.

7. The method of claim 1, wherein the verifying comprises determining that the terms in the query appear in the same order in the document as they do in the electronic image.

8. A computer implemented method, the method comprising:
obtaining an electronic image containing depictions of characters;
obtaining an initial optical character recognition output for the electronic image;
identifying as potentially accurate a set of subsections of the initial optical character recognition output to generate a query;
obtaining a search result corresponding to a document and responsive to the query, wherein the obtaining the search result indicates that a first resource on a network and a second resource on a network both contain a copy of the document;
selecting from among the first resource and the second resource based on at least a number of links to the first resource and a number of links to the second resources;
verifying text in the search result matches the depictions of characters; and
outputting computer readable text from the document.

9. The method of claim 1, further comprising calculating a distinctiveness score for each of the one or more segments.

10. A system comprising:
one or more computers configured to perform operations comprising:
obtaining an electronic image containing depictions of characters;
obtaining an initial optical character recognition output for the electronic image, wherein the initial optical character recognition output comprises one or more segments of one or more terms;
identifying as potentially accurate one or more of the segments of the initial optical character recognition output;
generating a query that comprises terms from one or more of the potentially accurate segments of the initial optical character recognition output;
obtaining, responsive to the query, a search result that corresponds to a document;
verifying that text in the search result matches the depictions of characters; and
outputting computer readable text from the document that corresponds to the search result as at least a portion of a final optical character recognition output for the electronic image.

11. The system of claim 10, the operations further comprising:
generating multiple queries, wherein each query comprises terms from one or more of the potentially accurate segments of the initial optical character recognition output; and
obtaining at least one search result for each of the multiple queries.

12. The system of claim 11, the operations further comprising attributing a rating to each of a plurality of search results, wherein a rating for the search result corresponding to the document is an extremum among ratings for others of the plurality of search results.

13. The system of claim 12, wherein the rating for the search result corresponding to the document comprises a sum of a plurality of ratings for the search result corresponding to the document, each of the plurality of ratings corresponding to a different one of multiple pluralities of the multiple queries.

14. The system of claim 10, wherein obtaining the search result further comprises:
providing the query to a search engine;
obtaining a plurality of search results for the query from the search engine; and
selecting the search result corresponding to the document from the plurality of search results.

15. The system of claim 10, the operations further comprising matching portions of the initial optical character recognition output to a stored set of known words.

16. The system of claim 10, the operations further comprising determining that the plurality of terms in the query appear in the same order in the document as they do in the electronic image.

17. A system comprising:
one or more computers configured to perform operations comprising:
obtaining an electronic image containing depictions of characters;
obtaining an initial optical character recognition output for the electronic image;
identifying as potentially accurate a set of subsections of the initial optical character recognition output to generate a query;
obtaining a search result corresponding to a document and responsive to the query;
selecting from among a first resource containing a copy of the document and a second resource containing a copy of the document based on at least a number of links to the first resource and a number of links to the second resource;
verifying that text in the search result matches the depictions of characters; and
outputting computer readable text from the document.

18. The system of claim 10, the operations further comprising calculating a distinctiveness score for each of the one or more segments.

19. A non-transitory computer readable medium storing instructions which, when executed by one or more computers, cause the one or more computers to perform operations comprising:
obtaining an electronic image containing depictions of characters;
obtaining an initial optical character recognition output for the electronic image, wherein the initial optical character recognition output comprises one or more segments of one or more terms;
identifying as potentially accurate one or more of the segments of the initial optical character recognition output;
generating a query that comprises terms from one or more of the potentially accurate segments of the initial optical character recognition output;
obtaining, responsive to the query, a search result that corresponds to a document;
verifying that text in the at least one search result matches the depictions of characters; and
outputting computer readable text from the document that corresponds to the search result as at least a portion of a final optical character recognition output for the electronic image.

20. The computer readable media of claim 19, the operations further comprising:
generating multiple queries, wherein each query comprises terms from one or more of the potentially accurate segments of the initial optical character recognition output; and
obtaining at least one search result for each of the multiple queries.

21. The computer readable media of claim 19, the operations further comprising attributing a rating to each of a plurality of search results, wherein a rating for the search result corresponding to the document is an extremum among ratings for others of the plurality of search results.
